(19) United States
(12) Patent Application Publication
(10) Pub. No.: US 2007/0073589 A1
(43) Pub. Date: Mar. 29, 2007

(54) Electronic capture of promotions

(76) Inventors: David L. Vergeyle, Long Lake, MN (US); David C. McClanahan, Portland, OR (US); Barry M. Pon, Milbrae, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/595,110

(22) Filed: Nov. 9, 2006

Related U.S. Application Data
(63) Continuation-in-part of application No. 10/982,326, filed on Nov. 4, 2004.

(51) Int. Cl. G06Q 30/00

(52) U.S. Cl. 705/14

(57) ABSTRACT

Multiple different advertisements each containing a different promotion are electronically displayed on electronic displays placed throughout a store. A consumer selects and captures one of the displayed promotions by entering the consumer identification and the identification of the selected promotion at a consumer interface device corresponding to the display presenting the promotion. The consumer identification is then associated with the promotion. This association is then processed by a database server and the promotion is communicatively transmitted to the consumer electronically according to the contact information stored on record for the consumer.

### TECHNICAL FIELD

This disclosure relates generally to the electronic capture and communication of promotions, and in particular but not exclusively, relates to the electronic capture and communication of promotions displayed on electronic displays.

### BACKGROUND OF THE INVENTION

Promotions are often displayed in commercial settings, such as in a grocery store. Typically, such promotions may appear on printed signage proximate to the goods to which the particular promotion may apply to. For example, printed coupon dispensers may be placed in an aisle near the physical location of the goods associated with the coupon. A consumer is then required to take the printed coupon along with the associated goods to the checkout or point-of-sale (POS), where the consumer presents both the coupon and goods prior to completing the sale. One disadvantage with this system is that the consumer must retain the physical coupon for each item while shopping, which may be cumbersome to a shopper having many items. Furthermore, the consumer is required to present each coupon at checkout, requiring the POS attendant to manually sort through the coupons to determine applicability prior to processing them, which can increase the time a consumer spends at checkout.

In addition, advertisers and promoters are often concerned with attracting, understanding and maintaining consumer interest in a promotion for an associated product. In an attempt to attract consumer attention, much effort is put into developing both printed and electronic graphical displays that are visually attractive. Consequently, consumers are often exposed to numerous promotional materials upon entering a grocery store, which may lead to complacency when presented with a promotion. Thus, there is a need to maintain the consumer's attention once the promotion has been presented to them, such that the consumer is compelled to perform some action related to the promotion, such as obtaining a coupon or purchasing specific goods.

Enabling the consumer to directly respond and interact with the advertising promotion establishes a line of direct communication with advertisers and promoters so that the consumers' interests are understood. Through means of interactive communication, consumers can also take advantage of special offers as well as sending promotions, offers, and coupons to themselves or to friends, families and third parties. This feature further allows advertisers and promoters to expand the exposure of the advertisements and promotions beyond the store environment into the daily lives of customers.

### SUMMARY OF THE DESCRIPTION

The present invention relates to electronic capture and interactive communication of coupons, advertisements and promotions. In one embodiment of the invention, promotional content is electronically displayed throughout a store. A consumer may capture one of the displayed promotions by providing consumer identification or other input at a consumer interface device located in the aisle corresponding to the electronic displays showing the promotion. The consumer identification is then associated with the promotion. This association is then integrated with the store's point-of-sale (POS) systems, such that when the consumer presents a product associated with the promotion for purchase at the POS, the POS applies the promotion (e.g. discount) to the sale. Interaction with consumer interactive devices allow consumers to take advantage of special promotions and communicate them to third parties and to extend the promotions and advertisements into the consumers' lives such as when consumers elect to send themselves or other third parties reminders of new products and future promotions.

The present invention is described in conjunction with systems, clients, servers, methods, and machine-readable media of varying scope. In addition to the aspects of the present invention described in this summary, further aspects of the invention will become apparent by reference to the drawings and by reading the detailed description that follows.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates a system level overview of an embodiment of a promotion capture and communication system.

FIG. 2 illustrates an embodiment of an electronic display 200.

FIG. 3 illustrates an embodiment of an electronic promotion capture and communication method.

FIG. 4 illustrates an embodiment of a back office tool set.

FIG. 5A illustrates an embodiment of an operating environment suitable for practicing the present invention.

FIG. 5B illustrates an embodiment of a computer system suitable for use in the operating environment of FIG. 5A.

FIG. 6A illustrates an embodiment of an advertisement with promotion and instruction for consumer interaction on screen.

FIG. 6B illustrates an embodiment of an interface device with instruction for consumer to interact with the interface device.

FIG. 6C illustrates an embodiment of the interaction of devices in a store.

FIG. 7A illustrates an embodiment of the information flow and interaction among devices.

FIG. 7B illustrates an embodiment of the interaction between database server(s) and stores.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

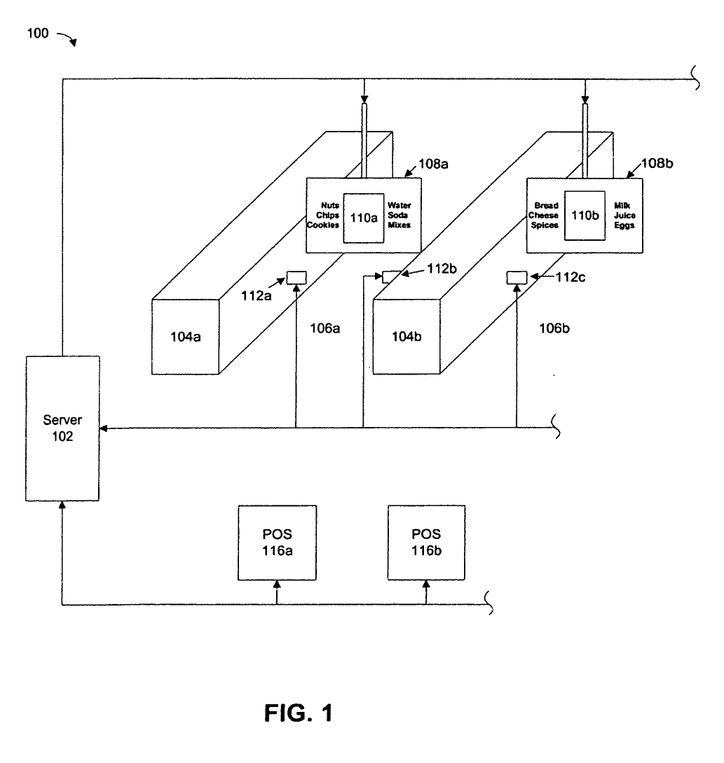

FIG. 1 illustrates a system level overview of an embodiment of the invention. According to an embodiment of the invention, promotional content is displayed throughout a store. The display includes, but is not limited to, the form of an electronic display on an active screen, an electronic display on a passive screen, video walls, displays integrated into the floor, ceiling, rafters and even a paper board, a cartoon board or any type of visual display. However, for the purpose of this disclosure, the display will generally be described in the form of an electronic display device such as an active device such as a plasma display, liquid crystal display (LCD), cathode ray tube display, video walls or other types of well known electronic display devices, etc. A consumer may capture one of the displayed promotions by providing consumer identification or other inputs at a consumer interface device located near the electronic display displaying the promotion. The consumer identification is then associated with the promotion. This association is then integrated with the store's point-of-sale (POS) systems, such that when the consumer presents a product associated with the promotion for purchase at the POS, the POS applies the promotion (e.g. discount) to the sale. An additional option available for the consumer to select is for the advertiser promoter to contact the consumer when future promotions become available or for consumer to directly send a reminder to himself or herself or even other third parties about the current promotion or a future promotion so they can act on that promotion at a later date.

For purposes of clarity, embodiments of the present invention will be described primarily with respect to a grocery store environment; however, it will be understood that embodiments of the present invention are not limited to such an environment, and instead are applicable to a wide variety of commercial environments, such as retail stores, wholesale warehouses, and other locations or environments where commerce may be transacted.

In one embodiment, a promotion capture system 100 includes a server 102 communicatively coupled to electronic displays 110a, 110b consumer interface devices 112a, 112b, 112c, and point-of-sale (POS) terminals 116a, 116b. In other embodiments, various elements of the system 100 may be communicatively coupled to each other directly, without passing through server 102. For example, in one embodiment, consumer interface device 112a is communicatively coupled to the electronic display 110a. In one embodiment, server 102 is located within the store or location in which the electronic display is located. Generally, server 102, which inherently functions at least as a local database and/or a communication point, is located within the store where the consumer interface devices 112a-c, the electronic displays 110a-b, and the point of sale terminals 116a-b, are located. Aisle directories 108a, 108b are textual or graphical displays that typically are hung above an aisle 106a, 106b to assist a consumer in locating items within the store. In a grocery store or supermarket, for example, an aisle 106a is formed between two product shelves 104a and 104b. Shoppers typically access goods placed on the shelves 104a, 104b by traversing an aisle 106a. In one embodiment, each aisle directory 108a, 108b is a signage that lists the types of items or goods that may be found on its respective aisle. For example, aisle directory 108a lists items such as Nuts, Chips and Cookies, which may be found on the portion of product shelf 104a facing aisle 106a. In one embodiment, each aisle directory 108a, 108b includes an electronic display device 110a, 110b such as a liquid crystal (LCD) display, a cathode ray tube (CRT) monitor, or other types of well-known electronic display devices. In another embodiment, each display device 110a, 110b may display content associated with more than one advertisement or promotion at a time. Different advertisements containing different promotions may be cycled periodically while multiple advertisements promotions are displayed simultaneously on different parts of the display.

In one embodiment, server 102 controls the promotional content that is presented on the electronic displays 110a, 110b. The promotional content includes content describing promotional events such as general product or service advertising, discount offers such as coupons, sweepstakes and contest entries, some or all of which may be currently available in the store, not available in the store, and can also include preview of new products, among other types of promotions. For example, the promotional content may be advertising a discount coupon for a new and not yet available product.

In one embodiment, the promotional content is designed to attract the consumer's attention, in order to entice the consumer to enter the aisle or to purchase a particular product. The advertising and promotional content presented on display devices 110a, 110b may include graphical content, such as full-motion video, animations, graphics stills, or vector-based graphics (e.g. JPEG, GIF images, etc.). In one embodiment, a combination of graphics and motion are used to draw the attention of consumers. In another embodiment, an audio output device, such as a speaker, may be associated with the promotional content displayed on the display devices 110a, 110b.

In one embodiment, server 102 assigns different promotional content to be displayed for each aisle 106a, 106b. In one embodiment, server 102 assigns promotional content based on the types of goods that are located on the particular aisle. For example, server 102 may cause promotional content to be displayed on display device 110a describing a savings coupon available on a particular Chips product, while server 102 simultaneously causes promotional material to be displayed on a different display device 110b describing a “Buy One, Get One Free” promotion for a particular Bread product. In one embodiment, either the electronic display 110a, 110b or another portion of the aisle directory 108a, 108b includes content directing the consumer to interact with the consumer interface device 112a, 112b. In another embodiment, the promotional content can be selectively downloaded from the server, and displayed on the electronic display 110a, 110b, where the downloaded promotional content is cycled or rotated periodically. For example, the particular promotion displayed may change every few seconds or minutes while different sets of multiple advertisements, which are changeable and replaceable, are selectively downloaded from the server on a different periodic basis such as every day, week, or month etc.

In another embodiment, a display 110a displays promotional content for products located elsewhere than on the particular aisle or section in which the display 110a may be located. For example, the promotional material may be associated with products or services available at another business or location.

In a different embodiment, the electronic displays 110a, 110b may display promotional content for products and services that are not currently available but that are to be offered at a future date. In yet another embodiment, the electronic displays 110a, 110b can display inquiries for customer surveys and feedbacks associated with a special promotion where a consumer will be rewarded with a special gift or reward upon completing a survey or questionnaire.

When a consumer is presented with promotional content displayed on one of the electronic display 110a of the aisle directory 108a, for example while shopping or traversing an aisle, the consumer may desire to participate in the promotion. In one embodiment, where a promotion is shown on display 110a, a consumer is able to participate in the promotion (also referred to as capturing the promotion) by providing information to a consumer interface device 112a located on shelf 104a of aisle 106a.

In one embodiment not shown, the consumer interface device 112a, 112b includes or is proximate to content directing the consumer to interact with the consumer interface device 112a, 112b to capture the promotion displayed on the electronic display device 110a.

In one embodiment, the consumer interface device 112a, 112b is an interactive device for accepting input from the consumer. The input may be information from, about or associated with the consumer such as a consumer identification which may include typing in codes associated with items being promoted according to instruction on the display. In one embodiment, the input information is used to identify the consumer and the items being promoted in order to associate the promotion with the consumer. In one embodiment, the consumer interface device includes a keypad, a touch pad or other input device for accepting input from the user. The information may be provided by the consumer through presenting a card to the consumer interface device, such as a magnetic strip card, a smart card, or a card including a barcode. For example, in one embodiment, the reader may also be a magnetic strip reader for reading information stored on cards having magnetic strips. In another embodiment, the reader is an optical reader, such as for reading barcodes. In yet another embodiment, a contactless card may be used, such as a card including a radio frequency identification (RFID) chip, such as Visa™ or MasterCard™ “Tap and Go” cards. Still another embodiment has a consumer interface device includes a biometric identification interface, such as a fingerprint reader. The input received from the consumer at the consumer interface device may include the consumer's name, phone number, account number, personal identification number (PIN), or other information identifying the consumer. For example, a consumer may capture the promotion by swiping a customer loyalty or rewards card through a reader on the consumer interface device 112a. In yet another embodiment, a consumer may be assigned an account number or other identifying information by signing up with the store beforehand. Alternatively, in one embodiment, a consumer may sign up for the store's loyalty program through the consumer interface device 112a.

In one embodiment, there is a plurality of consumer interface devices located in aisle 106a. For example, in one embodiment, there are two consumer interface devices 112a, 112b on a single aisle 106a, one disposed on each side of the aisle 106a. In another embodiment, there may be a plurality of consumer interface devices on each side of an aisle. The consumer interface devices may be fixed or moveable. For example, in one embodiment, the consumer interface device may be carried by the consumer or attached to a shopping cart. In such embodiments, the mobile consumer interface device is capable of determining the most proximate display device 110a, so that the proper promotion may be captured by the consumer. In one embodiment, the consumer interface device is coupled to a power source in addition to the server 102. Still, in a different embodiment, the consumer interface device may be affixed to a shelf-edge or placed at a location obvious to consumers while still providing a clear, unobstructed view of the electronic display such that consumers can view and interact with the interface device while viewing the advertising and promotional content on the electronic displays. In another embodiment, the consumer interface device can be individually stand alone devices at locations which are obviously visible to consumers. In a different form, the consumer interface display device can be completely mobile. For example, it can be obtained with each shopping basket or each shopping cart.

The consumer interface device can be powered in a number of ways. Power source includes but are not limited to typical consumer non-chargeable batteries such as ‘AA’, ‘AAA’, ‘C’ sized batteries, lithium ion batteries, rechargeable batteries, solar power etc. To save power, there may be key strokes caching where multiple key strokes are recorded and sent at once rather than transmitting data over the network after each individual key stroke entry. Data transmission can also be prioritized where user information that is logically rank the highest be transmitted immediately whereas individual key strokes ranked lower in priority is cached and sent only after a number of key strokes are saved together and sent collectively. Obviously, if power is not an issue, each customer user entry will be immediately transmitted upon entry to give the quickest response to the user.

After receiving input from the consumer, the information received at the reader 112a is transmitted to the server 102 for processing. The reader 112a is communicatively coupled to the server 102 through either a wired connection or a wireless connection. In one embodiment, server 102 associates the information received at reader 112a with consumer identification, such as a consumer account number. The server 102 then determines which promotion to associate with the consumer identification. In one embodiment, the server 102 associates the consumer identification with the promotion displayed when the consumer information was provided. Thus, for example, in one embodiment, where display 110a presents a coupon for 50% off of a particular Cookie item, the consumer may capture the coupon by swiping a magnetic loyalty card at the consumer interface device 112a while the promotion for the coupon is currently displayed on the electronic display device 110a. In one embodiment, this relationship between the currently displayed promotion and the interaction with the consumer interface device may entice the consumer to capture the coupon or promotion before the electronic display 10a, 110b ceases displaying the promotion, or displays another promotion. By capturing and communicating the coupon or promotion, it is meant that the promotion is associated with the consumer identification.

In one embodiment, once determining which promotion to associate with the consumer identification, the server 102 activates or initiates the particular promotion for the consumer identification, for example, by turning on a flag, so that the store's POS system is able to determine whether to apply the promotion if the consumer performs the conditions required for the promotion (e.g. purchasing a particular product or combination of products). Similarly, the association of the promotion and advertisement with the consumer identification will also trigger a record in the insight reporting module of the system where consumer and customer purchase behavior is compiled to tailor promotion advertising, improve products and services offering and in general to improve marketing as part of a customer relationship management initiative.

In another embodiment, the consumer interface device 112a may present the consumer with a choice of a plurality of available promotions which may be captured. For example, in one embodiment, a consumer interface device 112a may present a consumer with a choice of selecting one (or more) of several promotions that were recently displayed promotions, e.g. a choice of the promotions displayed within the last ten minutes.

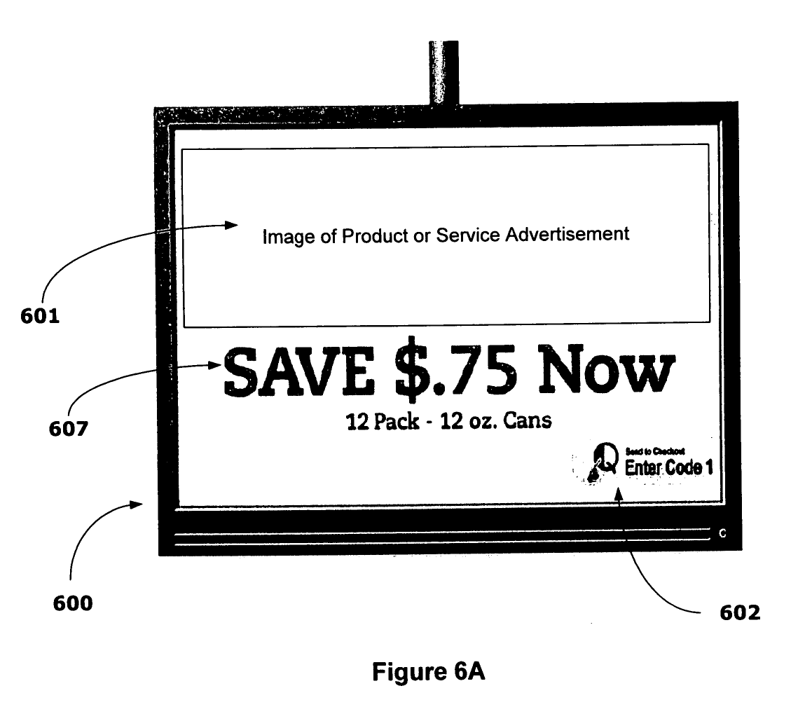

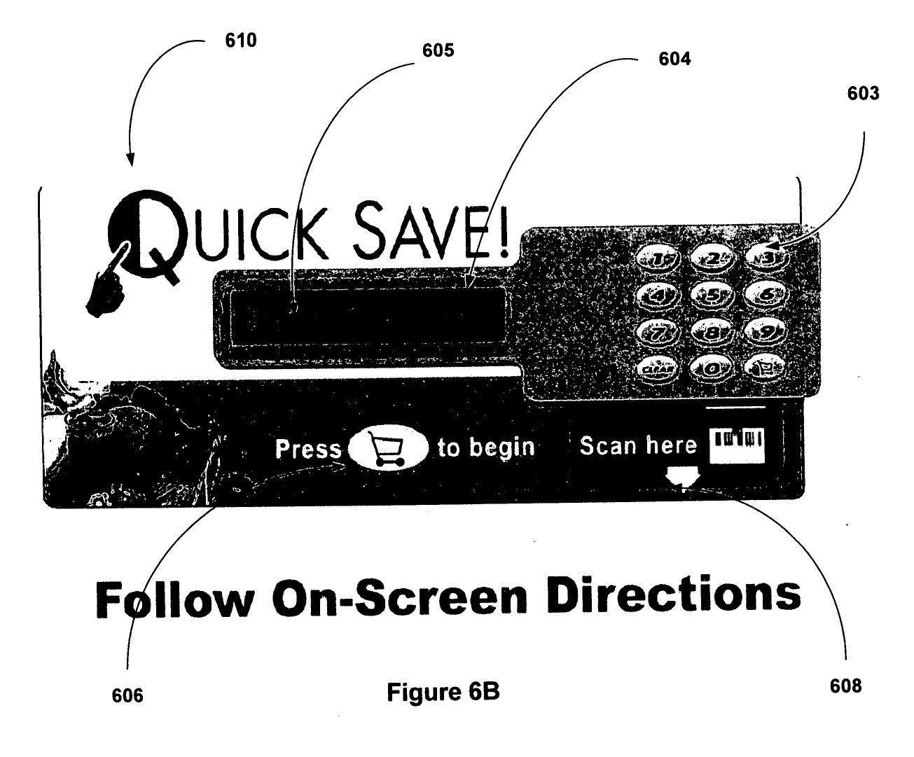

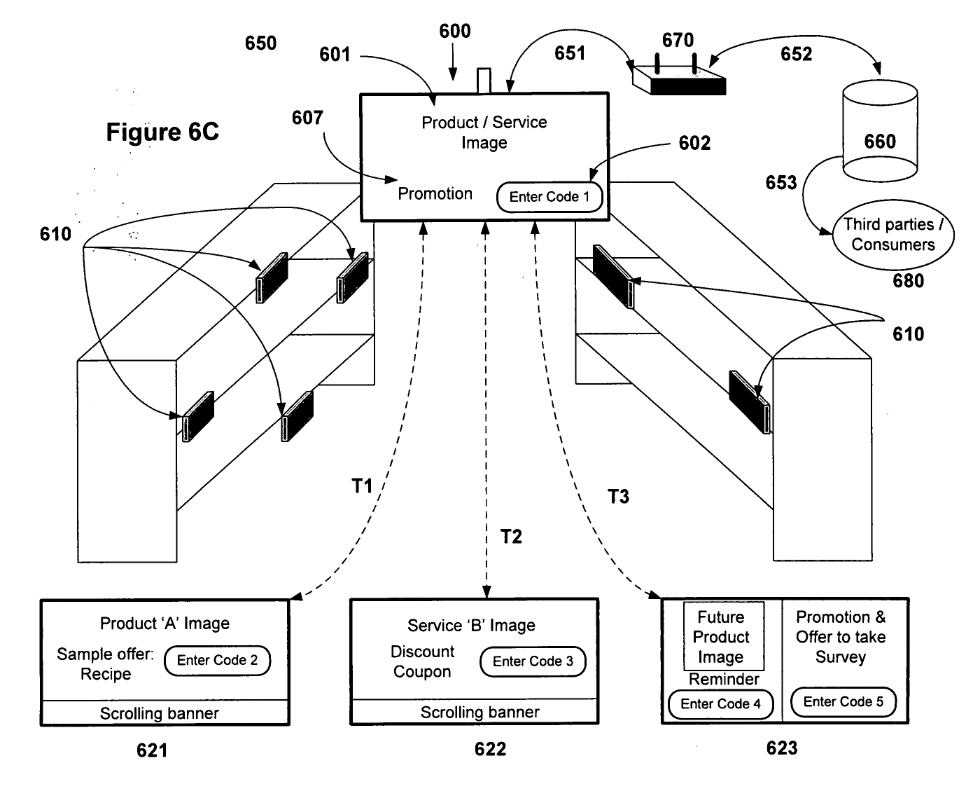

FIGS. 6A to 6B shows alternate embodiments where the electronic display devices and the consumer interface devices may present the consumer a manner of interaction to enter information identifying the particular promotion the consumer wants to capture. FIG. 6A illustrates an exemplary embodiment of the electronic display 600. The advertisement displayed may include an image of the product or service 601, the promotional offer 607, and instructions 602 or information on how to identify the promotion to the consumer interface device, such as “Send to Checkout Enter Code #1”. Consumers will follow the instructions as displayed on the right bottom portion of the electronic display 600, to capture the promotion. In an alternate embodiment, the electronic display may display multiple advertisements on one screen containing multiple promotions and multiple instructions on how to capture each promotion. In this alternate embodiment, the display screen can be split in half, in quadrants or simply divided into sections to accommodate the number of advertisements, promotional content, and instructions as necessary (detailed description to follow in FIG. 6C).

FIG. 6B illustrates an embodiment of an interactive device 610. A consumer is asked to follow on-screen directions 605, on the screen of the LCD alphanumeric display 604, and use either the keypad 603 or the product bar code scanner 608 to select the product or promotion as instructed on the LCD alphanumeric display 604, the electronic display 600 of FIG. 6A, or both. The interactive device shown in also has a button 606 to initialize the interactive device. The bar code scanner 608 can check the price of the item or used to read consumer information such as from a membership card, and the keypad 610 is used for manual data entry including consumer identification. In alternate embodiments, the interactive device may contain other forms of data reader such as a card swiper, biometric data reader or other combinations of forms of data entry. Generally, prior to data entry, an instruction to “Enter Code #” 605 appears on the screen of the LCD alphanumeric display 604. Once the consumer initiated contact with the interactive device by pressing the button 606, the instruction 605 on the LCD alphanumeric display 604 will disappear and the device will be ready for user input.

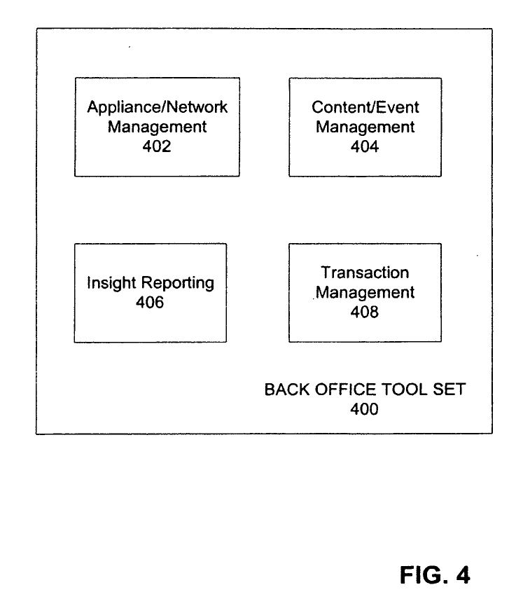

FIG. 6C illustrates the interaction among the different devices in a store. The devices which are found inside the store include one or more electronic displays 600, numerous interactive devices 610, one or more communication controls 670 and one or more database servers 660. The server 102 presented earlier can be represented by the communication control 670 while the database server 660 is often located outside of the store from which content is downloaded or where in-store data is to be uploaded. The database server 660 is also similar to the remoter servers on which the back end office tool set 400, as described later in FIG. 4, operates. The one or more database server(s) connected to the devices, and though it is typically placed outside of a store, it can also be situated within a store, such as the headquarter store. Generally in most embodiments, the communication server 670 is situated within the store in which the interactive devices 610 and the displays 600 are located. In one embodiment, the electronic display 600 containing multiple advertisements will display the promotion 607, the product or service image 601, and instruction 602, one advertisement at a time in a periodic fashion, for the consumer to interact with the interface devices 610. The interactive devices 610 are generally placed near the electronic display 600, such as on the shelf-edge of a product shelf, where the consumers have easy access while maintaining a clear visual view of the electronic display. The interactive devices 610 and the communication control 670 are connected via a wireless network, while the database server 660 is connected to the communication control(s) 670 via a wired or wireless connection 652. Database server 660 is further connected to third parties or consumers through connection 652 which can be a wireless or wired connection through the intemet to the world wide web. The electronic display 600 is shown to be connected to the communication control 670 via a wired connection 651, however, it should be known that a wireless connection is also possible. In a different embodiment, multiple database servers 660 can be connected to multiple communication controls 670 where each communication control 670 in a store is connected to multiple electronic displays 600 and multiple interface devices 610.

Although FIG. 6C demonstrates interface devices in one section used to capture promotions displayed on an electronic display in that section, it is possible in a different embodiment that the interface device may present the consumer with an option to capture a promotion displayed on an electronic display in different sections other than the one in which the particular consumer interface device is located. In one embodiment, upon successfully capturing a selected promotion, the consumer interface device or the display device may provide a graphical confirmation, such as a pop-up graphical icon, to relate the user that the promotion has been captured.

FIG. 6C also illustrates multiple forms of advertisements which can be displayed in the electronic device 600. In one embodiment 621, the electronic display 600 at time T1 will display the advertisement for product ‘A’, such as a can soup which is available on the shelves in the store, with a promotion offering a sample and a recipe. Furthermore, there is also a banner displaying news, weather, or other information on the bottom of the screen during the display of the advertisement. The banner can be continuously scrolling, or intermittently scrolling, also, an instruction can appear on the display to tell the consumers to “enter code 2”, instructing the consumers to interact with the interface device in order to participate in the promotion of obtaining a recipe.

In another embodiment 622, the electronic display 600 at time T2 will display the advertisement for service ‘B’ such as a window cleaning service, which is not available in the store. Similar to embodiment 621, there is also a scrolling banner on the bottom of the electronic display 600 below the advertisement and promotion. The promotion offers a discount coupon associated with the advertisement and instructs the consumer to “enter code 3” if the consumer wishes to participate in the promotion of the service.

In yet another embodiment 623, the electronic display 600 at time T3 will display more than one advertisement simultaneously on the screen of the electronic display 600. At time T3, the electronic display 600 will display two advertisements, side by side, on the screen, one offering a reminder for the consumer to visit the store when a future product becomes available, and another to offer the consumer with a special promotion if the consumer opt to take a survey. In these cases, the consumer can choose to participate by entering codes “4” and “5” for the respective different promotions. It should be known that multiple advertisements can be displayed on the electronic screen at any time, with or without a banner. Further, the banner may be on the top or the bottom of the screen.

The process of capture and transmission of promotions in FIG. 6C will now be described. This process begins with one or more database servers 660 downloading the multiple advertisements containing promotions and instructions to display the multiple advertisements through the communication controls 670 in stores. The communication controls 670 will selectively display the multiple advertisements containing the promotions in the electronic displays 600 according to the instructions downloaded from the database server 660 either at the same time or at a different time from when the multiple ads are downloaded from the database server 660. When the consumer decides to participate in any of the promotions, the consumer will enter into an interface device 610 his/her consumer identification and then the promotion code as instructed on the electronic display 600. The consumer identification and the promotion code will be transmitted via the communication control 670 to the database server 660. The database server 660 will store the data and also associate the user identification and the promotional information. If the promotion is a discount for a product, the database server will send an electronic coupon to the point of sale of the store from which the user data originates so that the consumer will automatically receive the discount on the item once the consumer checks out at the point of sale (not shown in FIG. 6C). On the other hand, if the promotion is for a sample offer such as a recipe, the server will automatically retrieve the contact information of the consumers, the sample offers and forward the promotional offer such as the recipe to the consumer or a designated third party.

In a different embodiment (not illustrated), by following the instructions on the consumer interface device 610 or the electronic display device 600, a future promotion scheduled for a later date, a promotion of a new product not yet arrived. The consumer may also elect to participate and be notified of future promotions scheduled for a later date or a promotion of a new product not yet released, and be contacted and reminded directly with a communication containing the information. The form of communication for the information may include, and not limited to, electronic mail, fax, telephone, instant message, text message, and regular paper mail. By following the instructions on the electronic display or the consumer interface device, the consumer may also elect to participate in a survey by entering feedback, response and comments in the consumer interface device to qualify for any concurrent special promotion. Lastly, the interface device 610 can set up to accept any feedback by the consumer regarding his or her shopping experience without the need to respond to a promotion or advertisement. The responses will be collected in the insight reporting module to improve in-store shopping experience through the customer relationship management.

In a different form, the consumer can act on an advertisement or promotion of a product or service not available in the store. In one example, a consumer sees an advertisement for a car dealer which offers the consumer a discount coupon for a sporting good store if the consumer test drives a vehicle at the dealer. Upon presenting the consumer identification to the interface device 610 so that the server can associate the consumer to the promotion, the customer can elect to choose one of multiple options including taking advantage of the promotional offer. One option is to print out the test drive promotion at the store and bring the promotion to the dealer, a second option is to communicate the information in text message or email to the consumer for the consumer to print the offer, a third is to send the consumer's information electronically to the car dealer so the consumer can visit the car dealer with his/her information already there. Similarly, the information can be sent to a third party designated by the consumer, who may be interested in the promotional offer.

As illustrated by the system presented in FIG. 1, in addition to capturing the promotion, the consumer may be required to procure or to select a particular item for purchase, e.g. a particular brand of Cookies to which the captured promotion applies. Thus, after capturing a coupon or promotion, the consumer may continue with their shopping, over the course of which they may capture additional promotions on either the same or different aisle, for other products or services. When the consumer desires to complete their shopping, they will approach the checkout line or point-of-sale (POS) 116a, 116b. In one embodiment, the POS 116a includes a cash register, typically administered by a human attendant, but it may also be fully automated, such as a self checkout kiosk. In one embodiment, a point-of-sale (POS) 116a is a terminal which is used to process financial transactions, such as the purchase of items or goods using cash, credit, or other payment means.

In one embodiment, POS 116a is communicatively coupled to server 102. At checkout, the consumer identifies themselves so that they any promotions for which they are eligible may be processed. In one embodiment, the consumer identifies themselves in a similar manner as they did when capturing a promotion. For example, the consumer may provide personal information to the POS 116a by directly entering the information at the POS 116a (e.g. via a keypad), swiping a loyalty card such as a magnetic strip card or a barcode.

At the POS 116a, the items are presented for purchase by the consumer, e.g. at a checkout, to be registered. For example, the items may be scanned using their Universal Product Code (UPC) barcode label, by manually typing in an associated product identification, or other known methods. Upon registering the items, the price associated with the item is determined and may be presented to the user, for example, as each item is scanned. In one embodiment, information in addition to the price may be presented, such as nutritional information for the product. In one embodiment, once all items have been registered at the POS 116a, the POS 116a determines whether any of promotions which the consumer has captured have been satisfied.

In yet another embodiment (not shown in FIG. 1), the customer consumer takes advantage of a sample offer or promotion on display and interacts with the consumer interface device to present customer identification to associate with a promotion and participate in the sample offering being promoted. For instance, if the promotion involves both a discount on a food product and a recipe associated with the food product, the consumer can elect to have the recipe communicated and sent to himself or herself in any of the forms of communication, such as text message, email etc. as described earlier, while the discount can be sent to the POS if the consumer elect to make a purchase at the checkout or as another communication if the customer elect to purchase the product in the future.

While at the POS, as most consumers are waiting in line to pay for their items, there can be displays and consumer interface devices set up near the POS to display special promotions and advertisements for products and services. They may include, but are not limited to, future promotions, new products not yet arrived, and products or services not provided in the store. Similarly the electronic display devices may solicit consumers' feedback about their shopping experiences. The purpose of the consumer interface device and electronic display device at the POS is to gather consumers' attention on product promotion advertising and to entice consumers to convey feedback and to communicate with the advertisers and promoters through promotions and offerings. The electronic display devices may further display useful information and tips, including, but not limited to recipes, home cooking tips, home cleaning tips, and other beneficial household, health related information to consumers along with promotions and advertisements. This can be used to generate good will and to enable consumers to send information to themselves or to third parties thus expanding the reach of the promotion and advertising beyond the vicinity of the store, and into consumers' daily lives. This set up can strengthen relationship with consumers as part of a bigger customer relationship management initiative.

In the embodiments described above, the system 100 may include a plurality of display devices 110a, 110b associated with a single aisle. In another embodiment, an aisle may include a plurality of consumer interface devicesi 12a, 112b, 112c. In yet another embodiment, the system 100 may include a plurality of point-of-sale locations 116a, 116b.

Server 102 may be communicatively coupled to the electronic display devices 110a, 110b, the consumer interface devices 112a, 112b, 112c, and the POS terminals 116a, 116b through either wired or wireless communication channels. In one embodiment, server 102 is coupled to electronic display devices 110a, 110b via a wireless connection complying with the IEEE 802.11x wireless standard including, but not limited to, 802.11a, 802.11b, 802.11g, 802.11i, 802.11n and 802.11fh etc. In another embodiment, server 102 may be coupled to the POS 116a through a connection using an Ethernet or other wired connection. Secure communication protocols may be used with the connectivity between the various components of embodiments of the invention, such as for example to encrypt data transmitted between devices.

In an alternate embodiment, the consumer interface device may be used by the consumer to download the promotion, for example, by downloading an electronic coupon into a portable storage device possessed by the consumer. The consumer may then present the storage device, which includes the electronic coupon, at the point-of-sale, where the promotion is applied to the sale. In one embodiment, the downloadable coupon is a coupon or promotion associated with the particular promotion then currently displayed on the display device 110a. In another embodiment, the consumer interface device is capable of printing or otherwise producing a physical coupon, such as a paper coupon, to the consumer for presentation at the point-of-sale to redeem the coupon or promotion. In one embodiment, the printed coupon is a coupon or promotion associated with the particular promotion then currently displayed on the display device 110a.

In embodiments where a consumer receives a printed coupon or downloading a coupon into a storage device, an increased level of privacy may be provided to the consumer, since the consumer is able to procure or download the promotion or coupon, without necessarily being required to provide personal information that may be used to identify that particular consumer. Thus, once an electronic coupon is downloaded to, for example, a smart card, or once a printed coupon is generated at the consumer interface device for the promotion then currently displayed on the aisle directory 108a display 110a, the consumer is then required to present either the smart card containing the electronic coupon, or the physical coupon itself, at the point-of-sale, after which the promotion is applied if the conditions are met (e.g. the product associate with the promotion is scanned at the POS for purchase).

In another embodiment, the consumer interface device may process financial transactions associated with the promotion displayed on the electronic display devices 110a, 10b. For example, if a service is advertised on the display device 110a, a consumer may be presented with an option to purchase the service through the consumer interface device, such as by swiping a credit or payment card. In yet another embodiment, a consumer may enter a sweepstakes or other contest by swiping their loyalty card or otherwise providing input at the consumer interface device.

In one embodiment, an electronic display device 110a, consumer interface device 112a, or both, may include a motion sensor. For example, using the motion sensor, when a consumer approaches the aisle 106a, a motion sensor on electronic display device 110a or the consumer interface device 112a detects the consumer's approach, and may then take some action, such as changing the content displayed on the display device 110a.

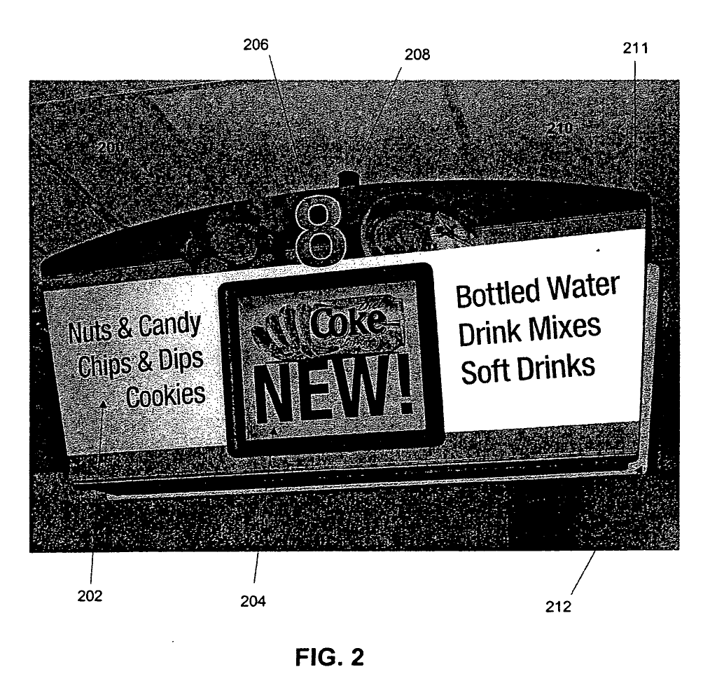

FIG. 2 illustrates an embodiment of an electronic display 204 incorporated into an aisle directory 200. For example, in one embodiment, aisle directory 108a of FIG. 1 may have the characteristics of the aisle directory illustrated in FIG. 2. Aisle directory 200 includes listing 202 of the types of products, goods, or items that are located in or near the respective section of the store in which the aisle directory is positioned. The term section refers to a particular location within a store, and includes, for example, an aisle (e.g. Aisle 8), as well as a department or area within the store that is not necessarily limited to an aisle layout (e.g. the Bakery). Typically, the listing 202 on the left side of the aisle directory 200 indicates items found on the left side of the aisle from the perspective of the viewer, while the right side lists items found on the right side of the respective aisle. The aisle directory 200 may include the aisle number 206 or other identification of the section or department of the store to which it applies. For example, in the embodiment illustrated in FIG. 2, aisle directory 200 is associated with aisle “8”, as designated by the aisle number 206. In one embodiment, either of the aisle number 206 and the item listing 202 may be static, printed, or otherwise non-electronically presented. In another embodiment, either of the aisle number 206 or item listing 202 may be presented electronically, such as graphically through a display device.

The electronic display device may be placed in the middle of the aisle directory. Furthermore, the electronic display device may itself incorporate the aisle directory so that no separate aisle directory is necessary. The items listing and aisle number can be displayed and changed electronically according to the items physically placed in the aisles.

Aisle directory 200 includes an electronic display device 204. As described above, the display 204 may be a display device, such as an LCD or CRT. More often, the electronic display device include, but is not limited to, a flat panel display, a plasma display, a digital light processing (DLP) display, a surface conduction electron emitter display device (SED) and any other display device which has the capability of providing high definition (HD) images as typically seen on an HDTV. In one embodiment, the display 204 presents graphical content, such as advertising or other promotional material. In one embodiment, the display 204 is coupled to a server or other content provider to receive promotional content for display presentation, such as graphics, text, or video. In one embodiment, the promotional content displayed on display 204 is associated with at least one product or item located or available on the respective section or aisle 206 of the directory 200. In one embodiment, a server, either located remotely or proximate to the directory 200 controls the content displayed on the display 204. The display 204 may rotate through different displayed promotional content at various intervals. Similarly, the display may simultaneously display multiple different ads and promotions where a series of different advertisements or promotions is being cycled through and each individual advertisement or promotion is being displayed in the same screen one at a time.

In one embodiment, the electronic display device 204 may be suspended from a ceiling 210, as illustrated in FIG. 2. For example, in one embodiment, a cylindrical support member 208 anchors the directory 200 and electronic device 204 securely to the ceiling or supporting members such as a rafter or beam. In another embodiment, the electronic display device 204 may be a stand-alone kiosk that is placed within the aisle, section, or department (e.g. supported by the floor of the aisle). In yet another embodiment, the electronic display device 204 may be positioned above the aisle, though not necessarily supported from the ceiling. For example, in one embodiment, the electronic display device 204 may extend over the aisle from a shelf, e.g. the top shelf. In another embodiment, the electronic display device 204 may be positioned above the aisle from an arm extending from behind and over products positioned on the top shelf of one side of the aisle. In still yet another embodiment, directory information, as well as the promotional information displayed on the electronic display device 204, may also be presented within the aisle by, for example, projecting directory and promotional information onto the floor from a projector positioned above the aisle.

In another embodiment, the directory 200 includes two electronic display faces or sides 211, 212. For example, the directory 200 may include a display 204 on two opposing sides of the directory 200, each side 211, 212 having a listing of items and a display device 204. For example, directory 200 may include a front face 211 and a rear face 212 (note that in the embodiment illustrated in FIG. 2, the content of rear face 212 is not illustrated). This would facilitate use of the electronic display device 204 from multiple viewing angles and locations. For example, by placing the electronic display device 204 in approximately the center of an aisle, consumers traversing the aisle from either direction would be exposed to content displayed on the electronic display device 204. Similarly, multiple electronic display devices 204 may be configured together in the center of the store where each electronic display device faces a different direction in the store such that any consumer can view at least one electronic display device, each containing different ads and promotions, such that any consumer can view multiple promotions and ads and interact with consumer interface devices as consumers see an ad or promotion that interest them. The consumer interface devices can be conveniently located and spread at or near aisles or they may be mobile devices carried by users.

In another embodiment, the directory 200 may be placed proximate to an end of an aisle, increasing the likelihood that consumers positioned throughout the aisle might be facing the display 204, thereby increasing the exposure of promotional content to the consumer. In one embodiment, a single aisle may include a plurality of electronic display devices 204. In one embodiment, aisle directories similar to that illustrated in FIG. 2 are disposed in a plurality of aisles in a store. In still yet another embodiment, the electronic display device may be placed in a section of the store that is outside of an aisle, for example, in the Bakery or Deli section or department of a grocery store. In such an embodiment, the display device of the electronic display device may present promotional content associated with products located in the particular section in which the electronic display device is placed.

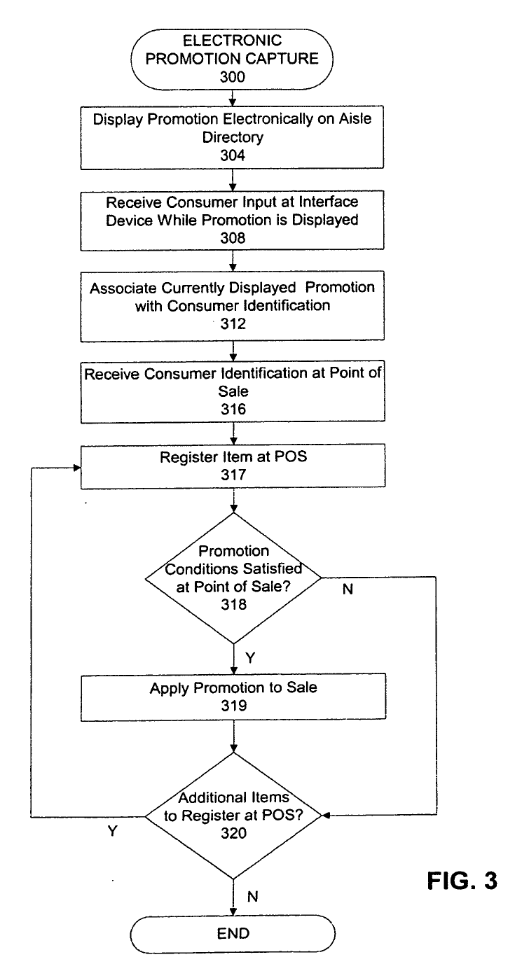

FIG. 3 illustrates an embodiment of an electronic promotion capture method 300. At block 304, the method 300 displays a promotion electronically on an electronic display device. In one embodiment, the promotion may be advertising content, for example, such as an advertisement for a discount on a product located on the aisle in which the promotion is displayed. If a consumer views the promotional content in the electronic display device, the consumer may wish to participate in the promotion, and/or to communicate the promotion to a third party or as a reminder to self. If a consumer desires to participate in a promotion, the consumer approaches a consumer interface device located in the aisle on the shelf edge. At block 308, the method 300 receives consumer input at a consumer interface device. For example, the consumer may initiate the communication by different methods including, but not limited to, swiping a magnetic card, scanning a barcode, inserting an electronic storage device, entering information via a keypad and providing a fmger print or other biometric data to the consumer interface device. In one embodiment, the input provided by the consumer is relayed to a server where the consumer is uniquely identified and associated with a consumer identification, such as by an account number, based on the input received. At block 312, the method 300 associates the promotion that was currently displayed on the aisle directory at the time the consumer input was received, with the consumer identification. In one embodiment, this association is stored (e.g. in a database) for later use, which may include, but is not limited to, measuring and tracking response to different ads and promotions. The response allow advertisers and promoters to device metrics in assessing the effectiveness of the various types of promotions as well as take into account consumer suggestions to improve shopping experience.

The consumer then may continue shopping and selecting items for purchase. When the consumer has completed their shopping, the consumer presents the items selected for purchase at a point-of-sale (POS) terminal. At block 316, the method receives consumer identification at the POS. For example, the consumer may identify themselves in the same manner in which they identified themselves at the consumer interface device, such as by swiping a magnetic card or scanning a barcode, inputting their name or phone number, etc. In one embodiment, the information received from the consumer is then relayed to the server, for example, to identify promotions that have been captured by the consumer or that are otherwise associated with the consumer identification. In one embodiment, at the POS, the consumer interface device, or both, where secure communication protocols including, but are not limited to, virtual private network (VPN), secure sockets layer (SSL), transport layer security (TLS), and point to point tunneling protocol (PPTP), may be used to provide secure transmission of sensitive data, such as consumer identification information. The transmission protocols such as those described above should use cryptographic tunneling protocols to provide the necessary confidentiality, sender authentication and message integrity to achieve the privacy intended.

At block 317, the method 300 receives identification of an item that is presented at the POS for purchase. For example, in one embodiment, each item is identified by scanning a UPC bar code or manually entering a description of the item into the cash register of the POS.

In one embodiment, at block 318, as each item is scanned or registered at the POS, the method 300 determines whether any of the promotions which have been captured by (or are associated with) the consumer have had their conditions met. For example, if a consumer captured a $2.00 off coupon for a particular product, the method 300 determines whether the consumer has presented that particular product at the POS for purchase.

If the method 300 determines at block 318 that conditions for a captured promotion have been met or satisfied (e.g. the consumer has presented the product associated with a captured promotion at the POS), the method 300 applies the promotion to the sale at block 319 (e.g. applies the coupon, reduces the purchase price of the item by 50%, etc.). The method 300 then determines at block 320 whether there are any additional items to register or scan at the POS. If there are additional items to register, the method 300 returns to block 317 to register the items.

If the method 300 determines at block 318 that the conditions for a captured promotion have not been met, the method 300 determines at block 320 whether there are any more items to register at the POS. If there are additional items to register, the method 300 returns to block 317 to register the items.

In an alternate embodiment, the electronic promotion capture method 300 determines whether the conditions of any captured promotions have been met only after all items are scanned or registered at the POS, rather than as each item is processed at the POS.

FIG. 4 illustrates an embodiment of a back office tool set 400. In one embodiment, the back office tool set is a group of component back end software applications used to manage the promotion capture systems and communications and methods of the present invention. In one embodiment, the back office tool set is implemented using at least one remote server computer. In another embodiment, the back office tool set may be implemented on at least one server computer that is remotely coupled to a local server in a store, such as server 102 of FIG. 1. In both aforementioned embodiments and in general, the back office tool set 400 is associated with a server that is not located in the store or at the same location as the interactive devices, display devices and the server or communication control. In yet another embodiment, the server 102 may implement the back office tool set 400 locally at the store site. In still yet another embodiment, where various components of the promotion capture and communications system are directly communicatively coupled without using server 102 as a hub point, the various components may individually or collectively implement at least a portion of the back office tool set functions. For example, in one embodiment, an embedded device within the electronic display devices 110a, 110b or consumer interface device 112a may implement the back office tool set functionality.

The back office tool set 400 includes an appliance and network management component 402, a content and event management component 404, an insight reporting component 406, and a transaction management component 408. In one embodiment, the back office tool set 400 includes web-based tools that are accessible remotely, for example, via the Internet through a web browser interface, to provide remote management and configuration capabilities for the promotion capture system.

The appliance and network management component 402 manages a network of appliances that are located in either a single store location or across a plurality of locations. This appliance and network management is responsible for managing the mechanics and interaction among components in the network. In one embodiment, the appliance and network management component 402 manages both the network itself as well as individual appliances. Appliances include the electronic display devices, the consumer interface devices, the local store servers, and the POS systems of an individual store. For example, a single store location may include about ten to twelve electronic display devices and up to ten times the number in consumer interface devices located around the store, each interface device and electronic device includes hardware (e.g. the display device) and software components (e.g. the promotional content displayed on the display device). Appliance and network management component 402 includes a network management (or network operations) ftnctionality, which ensures that the appliances are operating properly. For example, in one embodiment, the appliance and network management component 402 sends a status signal out to each appliance periodically (e.g. every hour) to monitor the appliances, to determine whether the appliance is operating properly. In one embodiment, where the back office tool set 400 is located remotely from the location of the store-level promotion capture system, the back office tool set 400 is coupled to the local store server (e.g. local store server 102 of FIG. 1) through a wide area network (WAN), such as the Internet. The appliance and network management component 402 communicates with individual appliances through the connection that is used locally in the store between the server and the appliance. For example, where the local in-store server is communicatively coupled to the electronic display device through a wireless network, the status and control signals from the back office tool set 400 components are transmitted to the local in-store server, then wirelessly routed from the store's access point to the appliance. The wireless communication transmission protocol included but are not limited to 802.11x such as 802.11 b, a, g, i, n and Bluetooth, where transmission can be in the range between about 2.4 GHz up to about 5 GHz and where the data transmission rate can range from as low as 40 kbps to as fast as about 54 Mbps.

In one embodiment, the appliance and network management component 402 pulls session logs from the networked appliances to determine various statistics regarding the appliances and their use, such as how many consumers captured a particular coupon or promotion, how did consumers capture the coupon (e.g. by entering phone number, swiping a loyalty card, etc.). In addition, the appliance and network management component 402 retrieves and generates error logs that may exist for the appliances or appliance peripherals, such as whether the appliance rebooted or froze up, or encountered another type of error or malfunction. Furthermore, the appliance and network management component 402 can monitor the battery level of each user interface device so that the battery can be proactively replaced before the power drop below the level for proper operation. For instance, each user interface device is uniquely identified, so when the low battery status alert comes on, the correct interface device can be properly maintained.

Content and event management component 404 allows for the management of the content displayed on any of the appliances, such as the promotional content that is displayed on the electronic display devices, as well as management of the promotional events (e.g. when and where the promotion is to be displayed). Since the promotions are likely to be changing frequently (e.g. they run for limited periods of time, in-store or out-of store products or services are added or removed, future or expired products and services are added and deleted, prices are adjusted, graphics are altered, etc.), the content will often needs to be managed. In one embodiment, the content and event management component 404 allows a user to select, for example, the graphics and/or language that is displayed on the display device as part of a promotion. In another embodiment, the content and event management component 404 also allows a user to perform events management, i.e. management of promotion characteristics, such as for example the duration of the promotion, disbursement (e.g. which aisle, market, stores or geographical location to display the promotion, etc.), and timing for display of the promotion, such as what time of day or what particular days to display the promotion.

In one embodiment, a store may use the content and event management component 404 functionality to manage the content displayed on the display devices. For example, a store manager may want to run a special promotion for a store brand product. In another embodiment, a third party content manager may handle the promotions displayed in the store. For example, a marketing specialty company may manage the promotional content displayed in the store. In yet another embodiment, a product vendor may access and manage the promotional content that is displayed in the store by using the content and event management component 404.

Overall, the content of the advertising promotions can be managed individually within each store. Further, the content can be managed for a number of stores in a particular geographical region where certain products and services are promoted at certain designated stores, or at certain times. Similarly, promotions can be based on the type of products being sold in the section of the store. The ability to manage advertising promotional content is limitless and can be based on factors including but not limited to, types of products and services, the time of day, the location of the stores, day of the week, the month in the year and holidays etc.

The content/event management component manages the promotional presentations on the electronic display device. For example, this component allows for marketing to approve and regulate the content and to manage what promotions to display, when and where. In one embodiment, the content management and event component 404 includes an approval loop. The approval loop provides the parties involved an opportunity to approve the promotional content or event characteristics. For example, where a third party marketing company creates the promotional content and designates it for display at particular times in particular store locations, the approval loop allows the store as well as the vendor to approve or reject the promotional content or event characteristics before the promotion is implemented in the store. This may be useful where, for example, a vendor is concerned with maintaining a consistent brand identity, or where a store is concerned about the appropriateness of the content displayed on the display devices as part of the promotion. Alternately, there can be a 2-level approval loop. In this instance, there are approvers for the content and then the acceptors must further accept it onto their network once the content is approved. Additionally, the approvals can optionally be set to automatically be approved or rejected after a predetermined time period.

Once promotional content and event characteristics have been approved using the content management component, the promotional content and the promotion event characteristics are published. In one embodiment, the publishing is handled by the content and event management component 404. For example, in one embodiment, an approved promotion is published by uploading the promotional content (e.g. graphics, video, audio, text, etc.) along with its respective event characteristics (e.g. time of display, frequency, location, etc.) to a store, such as through the store's local server or directly to the aisle directory.

The insight reporting component 406 provides statistical reporting for the promotion capture system, as well as reporting on aspects of the promotions themselves. For example, the reporting may include analyses of a particular promotion's efficacy, the number of consumers that captured the promotion, the time of day at which the promotion was captured (e.g. morning, afternoon or evening), store traffic measurements, and other analytically useful statistics that may be used to evaluate the degree of success of a particular promotion, or even the efficacy of a particular store's promotion capture system, for example, its layout.

The transaction management component 408 allows for the management of promotions for products or services that are not actually provided or stocked in the stores in which the promotion is run. For example, in one embodiment, if a promotion for a carpet cleaning service is displayed in an aisle directory of a grocery store, the consumer may capture the promotion, but the promotion is not performed at the store POS; rather, the carpet cleaning service would need to be notified that the consumer has captured the coupon, so that when the consumer identifies themselves to the carpet cleaning company, the promotion may be applied. In one embodiment, the transaction management component 408 would manage the notification of a third party, such as the carpet cleaning service, that a consumer has captured the displayed promotion. For example, in one embodiment, the notification may be in the form of an automatically generated email informing the third party that the promotion has been captured by a particular consumer.

In another embodiment, where a displayed promotion may be captured at the consumer interface device, the transaction management component 408 may handle both the notification to a third party vendor that the consumer has captured the promotion for the associated product or service. For example, where a displayed promotion is associated with a product or service not stocked at the particular store where the promotion was run (e.g. a promotion for tires run at a grocery store), the transaction management component 408 notifies the tire vendor that the consumer captured the promotion and thus is entitled to receive the promotion if any conditions are subsequently met.

In another embodiment, the transaction management component 408 may also process payment to a party other than the store where a particular promotion is displayed. For example, in an embodiment where the particular promotion displayed is one which allows for the consumer to instantly make a payment at the consumer interface device for a product or service associated with the displayed promotion, the transaction management component 408 processes the payment. In one embodiment, where the promotion is for a product or service not available from the store in which the promotion is displayed, the transaction management component 408 is capable of forwarding the payment and/or consumer information (e.g. delivery address information) to the third party supplier. The manner in which the payment is made can include, but not limited to credit card, debit card, and other payment service or electronic banking service such as paypal, when the payment is made to a third party for products or services not available in the store where the promotion is displayed.

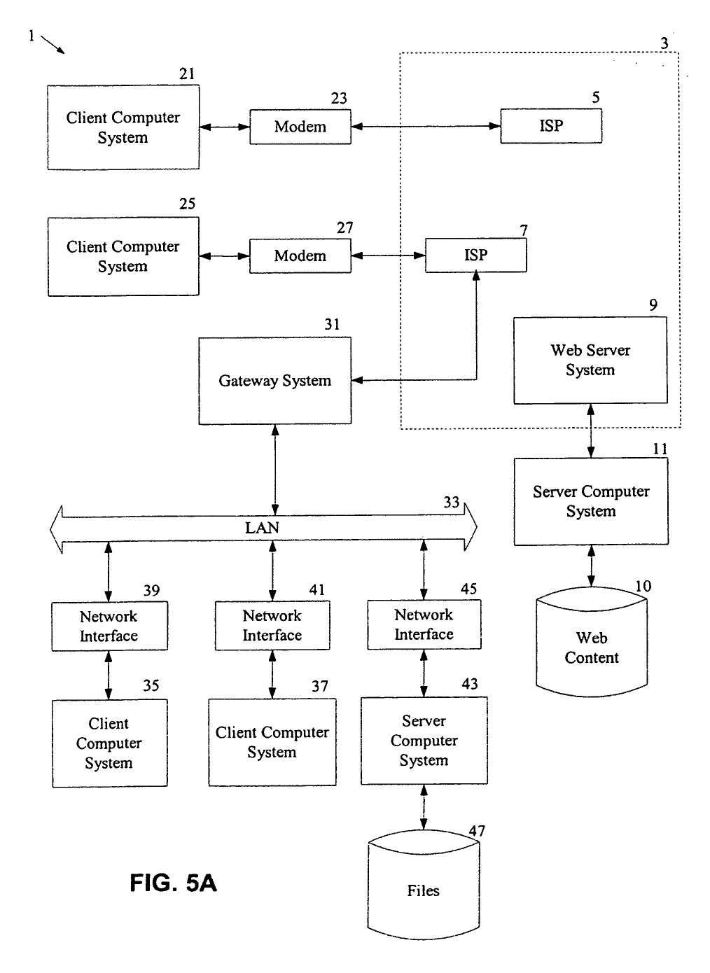

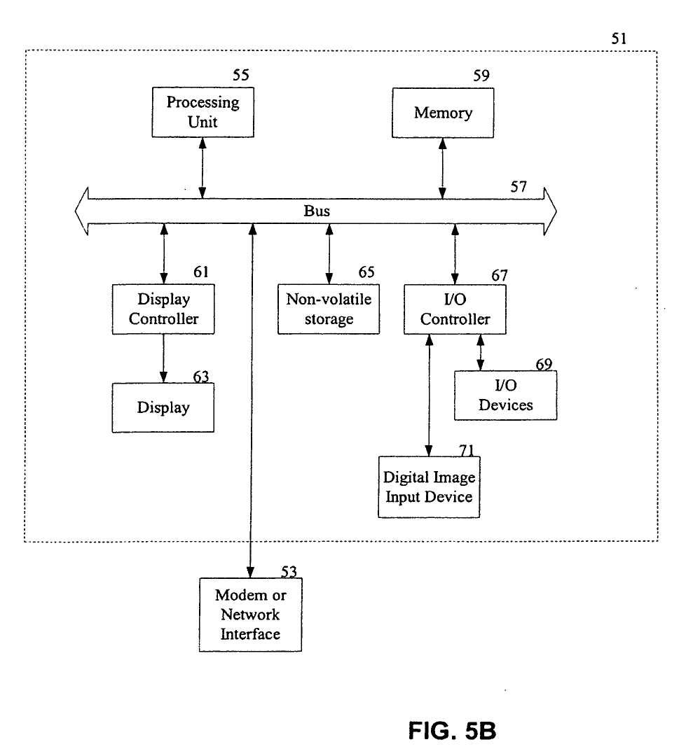

The following description of FIGS. 5A and 5B is intended to provide an overview of computer hardware and other operating components suitable for implementing embodiments of the invention described herein, but is not intended to limit the applicable environments. One of skill in the art will immediately appreciate that the invention can be practiced with other computer system configurations, including hand-held devices, cellular telephones, multiprocessor systems, microprocessor-based or programmable consumer electronics/appliances, network PCs, minicomputers, mainframe computers, embedded devices or PCs, and the like. Embodiments of the invention can also be practiced in distributed computing environments where tasks are performed by remote processing devices that are linked through a communications network.

FIG. 5A shows several computer systems 1 that are coupled together through a network 3, such as the Internet. The term “Internet” as used herein refers to a network of networks which uses certain protocols, such as the TCP/IP protocol, and possibly other protocols such as the hypertext transfer protocol (HTTP) or secured hypertext transfer protocol (HTTPS) for hypertext markup language (HTML) documents that make up the World Wide Web (web). The physical connections of the Internet and the protocols and communication procedures of the Internet are well known to those of skill in the art. Access to the Internet 3 is typically provided by Internet service providers (ISP), such as the ISPs 5 and 7. Users on client systems (or kiosks), such as client computer systems 21, 25, 35, and 37 obtain access to the Internet through the Internet service providers, such as ISPs 5 and 7. Access to the Internet allows users of the client computer systems to exchange information, receive and send emails and instant messages, and view documents, such as documents which have been prepared in the HTML format. These documents are often provided by web servers, such as web server 9 which is considered to be “on” the Internet. Often these web servers are provided by the ISPs, such as ISP 5, although a computer system can be set up and connected to the Internet without that system being also an ISP as is well known in the art.

The web server 9 is typically at least one computer system which operates as a server computer system and is configured to operate with the protocols of the World Wide Web and is coupled to the Internet. Optionally, the web server 9 can be part of an ISP which provides access to the Internet for client systems. The web server 9 is shown coupled to the server computer system 11 which itself is coupled to web content 10, which can be considered a form of a media database. It will be appreciated that while two computer systems 9 and 11 are shown in FIG. 5A, the web server system 9 and the server computer system 11 can be one computer system having different software components providing the web server functionality and the server functionality provided by the server computer system 11 which will be described further below.

Client computer systems 21, 25, 35, and 37 can each, with the appropriate web browsing software, view HTML pages provided by the web server 9. The ISP 5 provides Internet connectivity to the client computer system 21 through the modem interface 23 which can be considered part of the client computer system 21. The client computer system can be a personal computer system, consumer electronics/appliance, a network computer, a Web TV system that allows users to browse the internet from their TV, a handheld device, or other such computer system. Similarly, the ISP 7 provides Internet connectivity for client systems 25, 35, and 37, although as shown in FIG. 5A, the connections are not the same for these three computer systems. Client computer system 25 is coupled through a modem interface 27 while client computer systems 35 and 37 are part of a LAN. While FIG. 5A shows the interfaces 23 and 27 as generically as a “modem,” it will be appreciated that each of these interfaces can be an analog modem, ISDN modem, DSL modem, cable modem, satellite transmission interface, or other interfaces for coupling a computer system to other computer systems. Client computer systems 35 and 37 are coupled to a LAN 33 through network interfaces 39 and 41, which can be Ethernet network or other network interfaces. The LAN 33 is also coupled to a gateway computer system 31 which can provide firewall and other Internet related services for the local area network. This gateway computer system 31 is coupled to the ISP 7 to provide Internet connectivity to the client computer systems 35 and 37. The gateway computer system 31 can be a conventional server computer system. Also, the web server system 9 can be a conventional server computer system.

Alternatively, as well-known, a server computer system 43 can be directly coupled to the LAN 33 through a network interface 45 to provide files 47 and other services to the clients 35, 37, without the need to connect to the Internet through the gateway system 31.

FIG. 5B shows one example of a conventional computer system that can be used as a client computer system or a server computer system or as a web server system. It will also be appreciated that such a computer system can be used to perform many of the functions of an Internet service provider, such as ISP 5. The computer system 51 interfaces to external systems through the modem or network interface 53. It will be appreciated that the modem or network interface 53 can be considered to be part of the computer system 51. This interface 53 can be an analog modem, ISDN modem, DSL modem, cable modem, token ring interface, satellite transmission interface, or other interfaces for coupling a computer system to other computer systems. The computer system 51 includes a processing unit 55, which can be a conventional microprocessor such as a G3, G4, or G5 microprocessor from Motorola, Inc. or IBM, a Motorola Power PC microprocessor, or an Intel Pentium microprocessor. Memory 59 is coupled to the processor 55 by a bus 57. Memory 59 can be dynamic random access memory (DRAM) and can also include static RAM (SRAM), among other types of well-known memory devices. The bus 57 couples the processor 55 to the memory 59 and also to non-volatile storage 65 and to display controller 61 and to the input/output (110) controller 67. The display controller 61 controls in the conventional manner a display on a display device 63 which can be a cathode ray tube (CRT) or liquid crystal display (LCD) or any other electronic display devices as described earlier in this disclosure. The input/output devices 69 can include a keyboard, disk drives, printers, a scanner, and other input and output devices, including a mouse, other pointing device, or biometric data reader. The display controller 61 and the I/O controller 67 can be implemented with conventional well known technology. A digital image input device 71 can be a digital camera which is coupled to an I/O controller 67 in order to allow images from the digital camera to be input into the computer system 51. The non-volatile storage 65 is often a magnetic hard disk, an optical disk, FLASH memory, CD, DVD or another form of storage for large amounts of data. Some of this data is often written, by a direct memory access process, into memory 59 during execution of software in the computer system 51. One of skill in the art will immediately recognize that the terms “computer-readable medium” and “machine-readable medium” include any type of storage device that is accessible by the processor 55 and also encompass a carrier wave that encodes a data signal.

It will be appreciated that the computer system 51 is one example of many possible computer systems which have different architectures. For example, personal computers based on an Intel microprocessor often have multiple buses, one of which can be an input/output (I/O) bus for the peripherals and one that directly connects the processor 55 and the memory 59 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 59 for execution by the processor 55. A Web TV system, which is known in the art, is also considered to be a computer system according to the present invention, but it may lack some of the features shown in FIG. 5B, such as certain input or output devices. A typical computer system will usually include at least a processor, memory, and a bus coupling the memory to the processor.

It will also be appreciated that the computer system 51 is controlled by operating system software which includes a file management system, such as a disk operating system, which is part of the operating system software. The file management system is typically stored in the non-volatile storage 65 and causes the processor 55 to execute the various acts required by the operating system to input and output data and to store data in memory, including storing files on the non-volatile storage 65.

The present invention may also be embodied in an embedded, handheld or portable device containing a subset of the computer hardware components described above in the computer system 51. For example, the handheld device may be configured to contain only the bus 57, the processor 55, and memory 59 and/or 65. The present invention may also be embodied in a special purpose appliance, such as a kiosk, including a subset of the computer hardware components described above. For example, the appliance may include a processor 55, a data storage device 65, a bus 57, and memory 59, and only rudimentary communications mechanisms, such as a small touch-screen that permits the user to communicate in a basic manner with the device. In general, the more special-purpose the device is, the fewer of the elements need be present for the device to ftnction. In some devices, communications with the user may be through a touch-based screen, or similar mechanism.

The methods described herein constitute computer programs made up of computer-executable instructions illustrated as blocks (acts) within the flow chart of FIG. 3. Describing the methods by reference to a flow chart enables one skilled in the art to develop such programs including such instructions to carry out the methods on suitably configured computers (the processor of the computer executing the instructions from computer-readable media, including memory). The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result. It will be appreciated that more or fewer processes may be incorporated into the method illustrated in FIG. 3 without departing from the scope of the invention and that no particular order is implied by the arrangement of blocks shown and described herein.

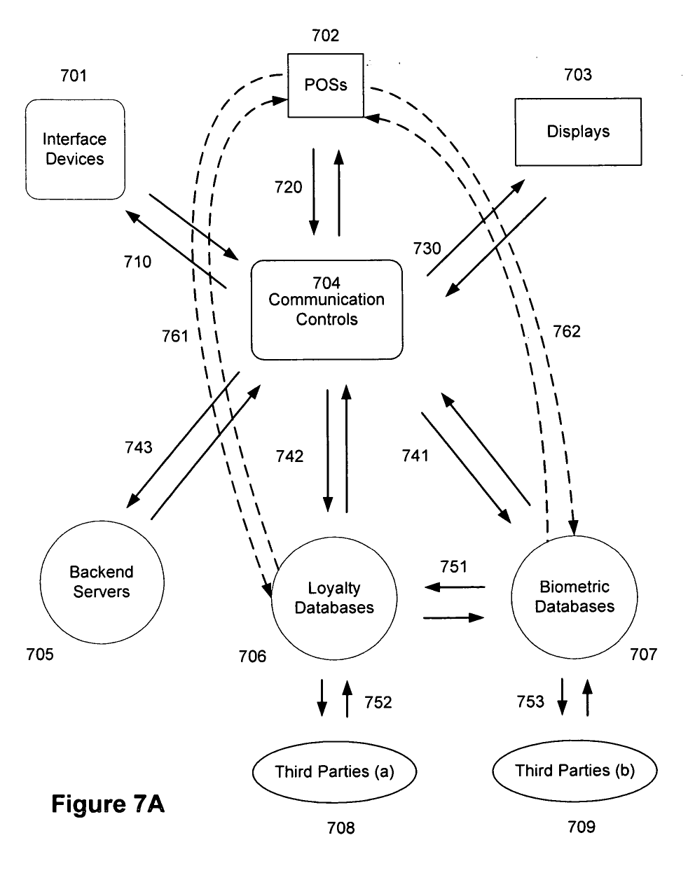

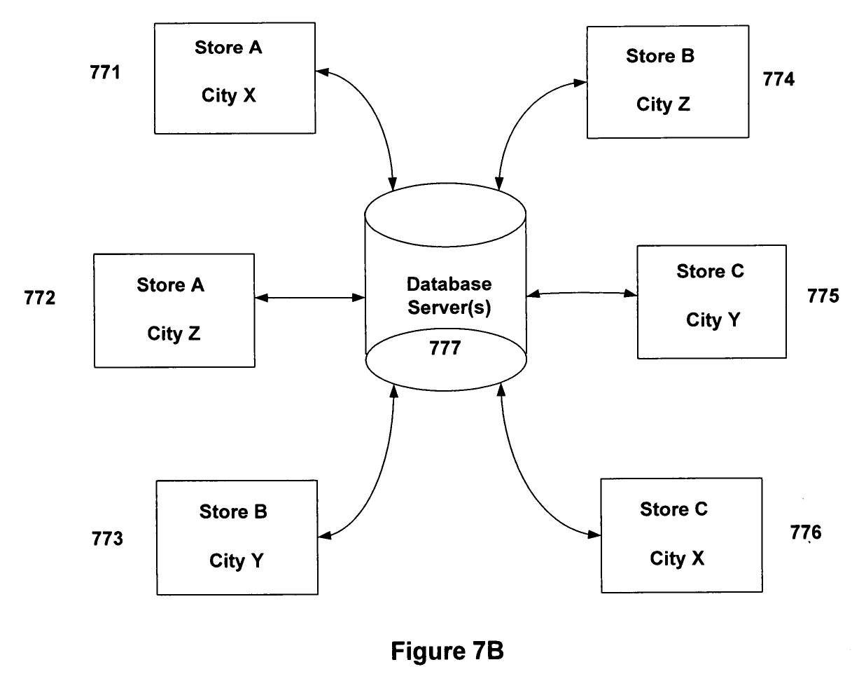

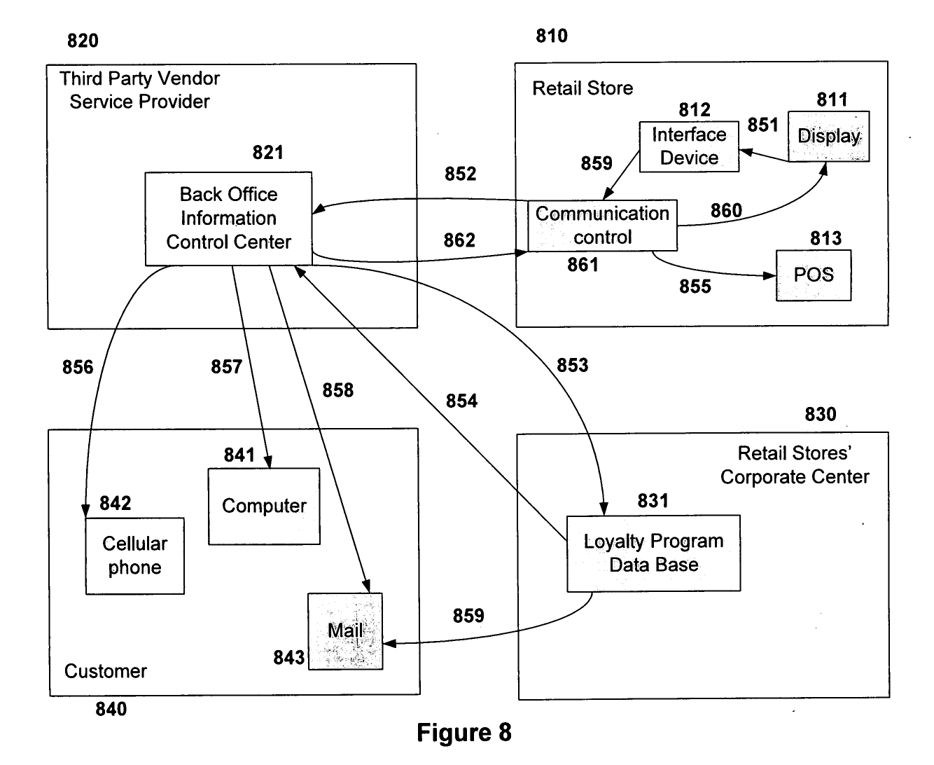

FIG. 7 illustrates the general flow of information in one embodiment of the system which is capable of electronic capture and communication of promotions. The communication controls 704 are responsible for controlling and directing communications with various in-store components of the system such as the interface devices 701, the electronic displays 703 and the POS 702. The communication control 704 is the same as the communication control 670 in FIG. 6 and functions similar to that of server 102 in FIG. 1. Each communication control 704 is typically an embedded personal computer (PC) or a computer with at least networking, storage and processing capabilities that are built for reliability. The communication controls 704 can be placed in a number of locations within the store including, but not limited to, embedded in the ceiling, behind the electronic display, within their own custom enclosures in a public area in the store, and even in a backroom in the store. Generally, the communication controls 704 are placed within a reasonable distance for communication with the various in-store components such as the electronic displays, the interface devices and the POS. Distance is only a factor if the communication is based on wireless or radiofrequency. Each communication control has at least various different forms of network connections, both wired and wireless, to communicate with the electronic display, the interface device, the POS, and the various databases. There is also at least one removable storage memory in the form of FLASH memory, DVD drive, a single hard drive, RAID, or other nonvolatile memory residing within the communication control 704 which stores the advertising promotional content and the instructions to which the advertising promotional content is to be displayed on the electronic displays. The communication controls 704 also run at least one software application, similar to the content manager described earlier, which executes the instructions on when and what to play in reference to the advertising promotional content being stored within.

The interface devices 701 are the means in which consumers interact and respond to the advertising promotions presented on the electronic display 703. The consumers use the interface devices 701 to enter their user identifications, to select the promotions they wanted and also to provide feedbacks, comments or communications which they intend to pass on to advertisers, promoters or a third parties. The interface devices 701 can be in one of many different configurations including, but not limited to, a keypad, a touch screen, a bar code reader, a magnetic strip or card swipe, buttons representing specific functions, a LCD screen with alphanumeric pad, a TFT LCD with video, a microphone, a biometric data reader, or any combination of the above. The interface devices 701 are often placed locations that can be easily accessible by consumers. In particular, they are often placed at locations where consumers can also at least have a direct view of at least one electronic display 703. Each interface device 701 can be mounted on a shelf edge, placed near products, at an aisle, hanging from a ceiling, and having its own custom stand, such as near the fruits and vegetables, among many examples of device placements. Two-way communication 710 between the interface devices 701 and the communication controls 704 involves the interface devices 701 sending user inputs to its corresponding communication control 704 where the user inputs are stored and then sent to other databases, and the communication control 704 sending system control commands and monitoring information to its corresponding interface devices 701 to control and monitor communications. Although the communication between the interface device 701 and the communication control 704 can be wired or wireless, the latter is preferred. When communication is wireless, it may utilize the IEEE 802.11x including, but not limited to, 802.11a, 802.11b, 802.11g, 802.11i, 802.11n, 802.11fh, any 2.4 GHz, infrared (IR), ZigBee, and any type of two-way radio frequency communication. Though generally the communication format 710 (e.g., wireless) used for the interface devices 701 to communicate with the communication controls 704 is different from that of the communication protocols (720, 730) (e.g., wired) used to communicate between the communication controls 704 and the electronic displays 703 or with the POS 702, they can also be the same.

The electronic displays 703 are used to present advertising promotions stored in the communication control 704 so consumers can select and participate in the promotions of interest. Displays are most commonly seen in the form of an electronic display, including, but not limited to a conventional CRT, LCD, a flat panel display, a plasma display, a digital light processing (DLP) display, a surface conduction electron emitter display device (SED) and any other display device that has the capability of providing high definition (HD) images as typically seen on an HDTV, as described earlier. Each display, as described earlier, often hangs from the ceiling but can also be displayed as a stand alone unit, within its own enclosure, or at any location which is near the product or commonly visible to consumers. Each display 703 has the ability to display multiple advertisements and promotions. Each display may show on its screen one or multiple advertising promotion at any one time. Thus, there can be a full screen of one advertisement, a screen divided into sections, quadrants or boxes, with each section, quadrant or box, each having its own content. There can also be an active banner on the screen that shows content such as news, traffic, weather or other information of interest to consumers. Also, as described earlier, the information presented in each display is targeted and personalized to be base on store locations, products in the store, vendors, time of year, services not available in store, or any of those combinations. The presentations of advertising promotions can be dynamic, as in a video, or static as in a presentation of a recipe. They may also include a combination of video and audio. Communication 730 between the electronic displays 703 and the communication controls 704 is generally one way, from communication controls 704 to the electronic displays 703. However, the communication 730 can also be two way, including not only sending of advertising promotions and instructions of displaying the promotions from the communication controls 704 to the electronic displays 703, but also status information sent from the electronic displays 703 to the communication controls 704 for monitoring the system status of the electronic displays 703. Communication 730 is generally achieved via a wired connection through video input/output due to the high bandwidth of data transfer. However, it is anticipated that the use of high bandwidth wireless communication protocols including, but not limited to, 802.11b, 802.11g, and 802.11n can meet also that requirement. Generally, one or two electronic displays 703 along with multiple interface devices 701 within the vicinity of the one or two electronic displays 703 are supported by one communication control 704. However, it is possible in the future that multiple electronic display devices 703 and multiple interface devices 701, together, can be supported by only one communication control 704. Currently, the independent content in each electronic display 703 is individually controlled by one communication control 704 such that each display has content which is customized and tailored according to location in which each display is placed. Similarly, it is expected that multiple presentations in multiple electronic displays 703 can each be independently controlled and supported by one communication control 704 to customized content presentation for different locations within a store.

Each POS 702 serves as a check-out or product purchase point, whether self-served or attendant-based, where items are scanned and the consumers pay for their items. Each POS is communicatively coupled to all the communication control via link 720. Each communication link 720 can include, but not limited to, a hard-wired intranet connection within the store's network, a wireless connection, or a hard-wired Ethernet connection which can access the internet beyond the intranet of the store. If wireless, the standard can be any of the ones as described above including, but not limited to 802.11b and 802.11g. The communication travels in both directions between the communication control 704 and the POS 702. Each communication control 704 can download information in the form of discounts and electronic coupons to apply to a particular product associated with the consumer during checkout. Each POS 702 sends information regarding its operation status to the communication control 704 so that monitoring of the POS can take place. In a different embodiment, all the POS can be connected directly to consumer loyalty databases or biometric databases residing beyond the store's intra-network, where the consumers' information are directly associated with the promotions selected (to be described further below). Since the databases reside outside of the network, they gain access to the POS 702 directly through Ethernet connections or gain indirect access to the POS 702 through the communication controls 704 which have Ethernet connections linked to the databases.

Generally, the communication controls 704, are connected to the internet via a network including, but not limited to, Ethernet, wide area network (WAN), local area network (LAN), either in hard wired or in wireless standards as described above. The connection to the internet permits each communication control 704 to communicate with a series of external servers that provide different functions to the overall system. These servers include, but are not limited to, backend servers 705, loyalty databases 706, and biometric databases 707. These servers are similar to the remoter servers as described in FIG. 4 on which the back office tool set 400 operates. Each of the connections, 743, 742, and 741 to the aforementioned servers, respectively, are directly through the internet or through various networks allowing access to the internet. These servers are generally not within the store's internal or intranet network because they are managed and operated separately, either by outside vendors, by store management, or by a third party managing the functions and communications of the system components. For instance, the backend servers 705 function to monitor the system status and control the interaction of the various components (701, 702, 703) with the communication controls 704 inside the store as well as the communication controls' 704 interactions with other servers. In the alternative, the devices in the store such as displays, interactive devices, can send a status report to the backend for regular reporting and maintenance.

Each loyalty database 706 stores consumer data and identification information, the advertising and promotional information and the instructions for displaying the information downloaded onto the communication controls 704. Further, the loyalty databases function to associate the user identification with the promotions selected by consumers. This data is also stored and used for analysis of consumer purchase behavior and to track and measure the responses to the advertisements and promotions. Thus, each loyalty database stores promotions, user information, associates user information to the selected promotions and also measures consumers' responses to promotions and advertisements. Each loyalty database 706 is capable of connecting to other database, such as biometric databases (to be described further) as in link 751, to associate consumer identification information. The loyalty database servers can also directly retrieve promotional information such as discounts or electronic coupons to send back to the POS 702 directly 761 or indirectly 742, 720 upon receiving the command from the communication controls 704. The loyalty databases 706 can also send communications such as email, text messages etc., through a direct link 752, to a third party 708. For example, when a consumer is interested in obtaining a recipe displayed in the store, the consumer enters in his/her user identification and promotional code or information, the communication control 704 then transmits the user identification and the promotional code or information to a loyalty database. The user identification and the promotional code information are associated, and the user's information is retrieved. The recipe is then emailed or text messaged to the consumer based on the contact information provided by the consumer stored within the database. Similarly, the recipient of a sample, a promotional offer, a promotional notice, or a future promotional reminder can be a third party recipient as designated by the consumer at the time of inputting the promotional request or otherwise stored within the loyalty database. Also, if the consumer desires to send feedback or comment to the store or to an advertiser promoter, the comment or feedback can be stored, retrieved, and/or redirected to the party according to a set of predetermined instructions.

The biometric databases 707 serve primarily as a depository of registered users' biometric data. If a biometric data reader is used in the interactive device 701, the biometric data received by the reader will be transmitted via the communication control 704 via links 710 and 741 to the biometric database 707 for verification. Often, each biometric database 707 needs to communicate with at least one loyalty database 706 via link 751 to verify and associate the user information with the promotion selected by the user. Once the users' data has been verified and associated, the associated information will be sent to the POS or to the third party as illustrated in the previous paragraph describing the loyalty database. However, in another embodiment, each biometric database 707 may contain the loyalty and promotional information so it does not require a connection to a loyalty database to verify user information and associate promotions. In this case, each biometric database 707 can either send the electronic discount information to the POS 702 directly via link 762, or indirectly to the POS 702 through the communication controls 704 via links 741 and 720. Also, each biometric database 707 may be able to directly send communications to the consumer or to a third party promoter 709 via the link 753.

FIG. 7B illustrates the interaction of the database servers and the different stores located in different geographical locations. The database server 777 is a single database which may be represented by a loyalty database, a biometric database, a backend server, or any combination thereof. The various different stores A, B, and C and various different geographical locations of cities X, Y, and Z are illustrated by 771-776. FIG. 7B illustrates that one database server connected to multiple different stores that sells different products or services, in different locations, is sufficient to control the multiple advertisements and promotions that are displayed in the different stores in the different locations. As described earlier, the display of advertisements and promotions can be controlled based on different products or services carried by the different stores (A, B, C) at different locations (X, Y, Z), and at a different time. This figure illustrates the possibility of having only one database server 777 to achieve this purpose. However, it is likely to be more efficient to have one backend server dedicated to monitor the communications and system functions of the device interactions in one or more stores, in additional to the one loyalty database or biometric database which is dedicated to storing consumer information and advertisement promotion information.

FIG. 8 illustrates an embodiment of the system described in FIGS. 7A and 7B implemented in a retail store. In a retail store 810, one of many retail stores of a chain or one of many different stores owned by different corporate parents, the components described before in FIGS. 6 and 7 are found. Displays 811 are used to display the promotions in store or promotional offers available in-store or out of store for in-store visitors; interface devices 812 are placed at strategic locations in the retail store 810 near the displays 811 and/or near the point of sales, POS 813. When an in-store customer is attracted 851 by the display and is interested in the offering appearing on the display, the in-store customer will follow instructions on the displays 811 or on the interactive devices 812 to interact with the device 812 to enter information such as phone number, club membership number or other identification information to identify himself/herself to the interface device 812. The interface device 812 then communicates the identification of the in-store customer to a server having a special application software, such the Back Office Information Control Center (BOICC) 821 which can be located outside of the store, under management by a unique third party vendor service provider 820, where communication of information is controlled.

Essence of the BOICC 821 is to be further described. The BOICC 821 serves as the brain to the entire system and can be seen in one configuration, as a combination of the database server 660 in FIG. 6C with a built in back end office tool set 400 as described in FIG. 4. BOICC 821 stores, assimilates, selects and sends information. For example, it sends 862 content information to the communication control 861 which then passes 860 the content to the display 811. Similarly, as described above, when a user enters information into the interactive device 812, the interactive device 812 first sends 859 the information to the communication control 861, and the communication control 861 in turn sends 852 the information to the BOICC 821. Further still, the BOICC communicates with the POS by relying on information transfers 862 and 855 via the communication control 861. While the communication control 861 is similar to the communication control 670 in FIG. 6C, and the communication controls 704 in FIG. 7A, it may effectively be seen as an integrated part or a natural extension of the BOICC 821. In other words, as an analogy, while the BOICC 821 acts as the brain of the system, the communication control 861 acts as the nerve that connects the brain to the limbs (represented by the interface device, display, and POS). Furthermore, the BOICC 821 can also be seen as the equivalent of one of the backend server 705 in FIG. 7A and/or the database servers 777 as described in FIG. 7B. As will be described later, although the BOICC 821 and the loyalty program database 855 are illustrated separately, the BOICC 821 can incorporate such a database as well. Thus BOICC 821 can be a server with special application software such as the back office tool set 400 in FIG. 4 or the server with special application software plus a database. In one embodiment not illustrated, the communication control 861 may interact directly with the loyalty database 831 to retrieve electronic coupons and customer data to apply at the POS 813 for checkout, without the need for the BIOCC 821. Otherwise, the information and communication in the system routes through the BIOCC 821 in almost all other cases.

As described, the BOICC 852 is the hub to the information flow among the retail store, the loyal program database 831, and the customer 840. Though the loyalty program data base 831 is illustrated to locate outside the confines of the Third Party Vendor Service Provider 820 at the retail store's corporate center 830, it should be known that this loyalty program database can also be integrated as part of the BOICC 821. In the present example, the BOICC 821 sends 853 the in-store customer's identification information to the loyalty program database 831 and the loyalty program database responds in a number of ways. For instance, the loyalty program database 831 sends 854 the in-store customer's contact information such as email address, mail address, cell phone number and/or fax number to the information communication center 821. The loyalty program database may also store and record the promotion, electronic coupon and/or offering as entered by the in-store customer through the interactive device 812 and associate that with other similar promotions , samplings, and/or offerings of other associated or related products. Furthermore, the loyalty program database can simply record the pattern of the in-store customer's shopping behavior to track a particular in-store customer's habits to tailor and/or target specific future offerings of products to that customer. Again, it is noted that the recording of shopping behavior to create target marketing, advertising, and promotion as described can also be performed at the BOICC 821.

In response to obtaining the in-store customer's personal contact information and recording the relevant shopping behavior information, the loyalty program database 831 can use the information to associate other promotions of the retail store's other related products by sending 839 samplings of products through mail to the in-store customer's home or contact address. Similarly, once the contact information of the customer is received and confirmed by the BOICC 821, it can immediately apply and send 855 the electronic coupon of the offering selected in-store to the POS so that the discount or coupon is automatically applied when the in-store customer checks out at the POS. Furthermore, the information communication control center can send 856 a confirmation of the electronic coupon selection via text messaging, for example, to the in-store customer's cellular phone for confirmation. Taking a few steps further, the BOICC 821 can also send 857 emails of related product offerings or other promotions in-store to the customer's computer or email address on file. Other marketing applications such as to promote products not offered in-store by partnership vendors can also be mailed 858 to the in-store customer's mailing address, all subjected to the in-store customer's profile, preferences, shopping behavior as indicated in the database 831.

In summary, the system of components as described above together functions as one unit that serves to promote and further the shopping experience of an in-store customer. This objective is achieved by automatically executing a number of tasks once the customer selected an electronic coupon or offering. The tasks includes sending the discount to the POS so that it is automatically applied when the in-store customer checks out, sending confirmation to the customer when a promotion, offering, or discount is selected, recording the shopping behavior of the customer, sending samples or sampling of products to the in-store customer, generating leads for other products by sending selective promotions based on shopping behavior to the in-store customer. Overall the system is designed to promote customer relationship, to enhancing the shopping experience of the in-store customer to an environment beyond the store, and to increase revenue for the retail stores and their partners.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A system to capture and to transmit promotions, comprising:
a plurality of stores where products and merchandise are sold;
a plurality of communication controls communicatively coupled to a plurality of interface devices, a plurality of points of sales, a plurality of electronic displays and at least one database server, the plurality of communication controls to direct information flow among the plurality of database servers, the plurality of interface devices, the plurality of electronic displays and the plurality of points of sales;
the plurality of electronic displays to display different advertisements selectively downloaded from the at least one database server, wherein different promotions contained in the different advertisements are capable of being selectively transmitted to consumers;
each of the plurality of interface devices capable to receive user inputs including consumer identifications and the different promotions that are displayed on at least one of the plurality of electronic displays and selected by the consumers, the plurality of interface devices to transmit the user inputs to the at least one database server which is capable to electronically transmit the different promotions selected by the consumers to the consumers;
the plurality of the points of sales capable to receive discount communications from the at least one database server, in association with the promotions selected by the consumers and the consumer identifications, to be applied when the consumers checkout; and
the at least one database server with the capability,
to store and to download the different advertisements and instructions to display the different advertisements on the plurality of electronic displays in the plurality of stores,
to receive, to store and to associate the user inputs including the consumer identifications and the different promotions selected by the consumers from the plurality of interface devices in the plurality of stores,
to retrieve contact information of the consumers based on the consumer identifications received from the plurality of interface devices in the plurality of stores, and
to transmit the different promotions selected by the consumers to the consumers.

2. The system of claim 1 wherein the plurality of communication controls is coupled to the plurality of interface devices through a wireless network and is coupled to the at least one database server and the plurality of electronic displays through a wired network.

3. The system of claim 1 wherein the plurality of communication controls is coupled to the plurality of interface devices, the plurality of electronic displays and the plurality of points of sales through a wireless network and is coupled to the at least one database server through a wired network.

4. The system of claims 2 or 3 wherein the wireless network is supported by an IEEE 802.11x standard wireless protocol or Bluetooth, and the wired network comprises an Ethernet connection with access to the internet.

5. The system of claim 1 wherein each of the plurality of electronic displays further comprises one of a LCD, a plasma screen, a CRT, a HDTV display, and a SED TV display, and the plurality of electronic displays are placed at a visibly prominent location including hanging from the ceiling, at a checkout line, and in its own enclosure near products sold in the store.

6. The system of claim 1 wherein each of the plurality of communication controls is in a store location not visible to consumers including inside the ceiling, a backroom, in a custom enclosure and attached to back of the electronic display.

7. The system of claim 1 wherein each of the plurality of interface devices comprises any one of a keypad, a touch screen, a card swipe, a magnetic card reader, and a biometric data reader.

8. The system of claim 7 wherein each of the plurality of interface devices has the capability to cache key strokes and to send data representing the user inputs collectively rather than sending one key stroke individually upon each entry.

9. The system of claim 7 wherein each of the plurality of interface devices is powered by at least one of rechargeable batteries, lithium ion batteries, and a solar panel.

10. The system of claim 7 wherein each of the plurality of interface devices is mounted on a shelf-edge or placed in a location where consumers can have easy access while maintaining a direct view to at least one of the plurality of electronic displays.

11. The system of claim 1 wherein the each of the different advertisements further comprises at least one of a promotion, discount, sample offer, customer survey, and a combination thereof for both products and services.

12. The system of claim 1 wherein the discount communication comprises a discount transmitted in the form of an electronic coupon relating to the consumer selected promotion.

13. The system of claim 1 wherein each of the promotions selected by the consumers that are transmitted to the consumers comprises at least one of a sample offer, a recipe, and a discount in a form further comprises at least one of a fax, an email, a text message and an instant message to the consumer.

14. The system of claim 1 wherein the at least one database server is further capable to analyze and to measure consumer responses to the different advertisements based on the associated user inputs received from the at least one of the plurality of interface devices in the plurality of stores.

15. The system of claim 1 wherein the plurality of communication controls, the plurality of electronic displays, the plurality of points of sales, and the plurality of interface devices located in different stores are communicatively coupled to a same plurality of servers that are not located in any of the different stores.

16. The system of claim 1 wherein the each of the plurality of the communication controls inside a store is communicatively coupled to one electronic display, multiple interface devices, and at least one point of sale.

21. A method to capture and to transmit promotions, comprising:
downloading selectively, different changeable advertisements, each containing a different promotion capable of being electronically transmitted to consumers, and electronic instructions for displaying the different changeable advertisements on a plurality of electronic display devices, from at least one database server to a plurality of communication controls communicatively coupled to the plurality of electronic display devices;
presenting the different changeable advertisements and the different promotions, each of the different promotions containing instructions instructing the consumers to participate in the different promotions by interacting with any of the a plurality of interface devices that are communicatively coupled to the plurality of communication controls, on the plurality of electronic displays;
receiving user inputs that include a consumer identification and identifications of the promotions as selected by a consumer according to the instructions on one of the plurality of electronic displays, on a correspond one of the plurality of interface devices;
transmitting the user inputs, including the consumer identification and the identifications of the promotions as selected by the consumer from the corresponding one of the plurality of interface devices, through one of the plurality of communications control communicatively coupled to that transmitting interface device, to the at least one database server;
receiving and storing the user inputs including the consumer identification and the identifications of the promotions selected by the consumer in the at least one database server;
associating the consumer identification and the identifications of the promotions selected by the consumer;
retrieving the consumer contact information stored in the at least one database corresponding to the consumer identification; and
sending the promotions selected by the consumer to the consumer.

22. The method of claim 21 wherein the plurality of communication controls are coupled to the plurality of interface devices through a wireless network and are coupled to the at least one database server and the plurality of electronic displays through a wired network.

23. The method of claim 21 wherein the plurality of communication controls are coupled to the plurality of interface devices, the plurality of electronic displays and the plurality of points of sales through a wireless network and are coupled to the at least one database server through a wired network.

24. The method of claims 2 or 3 wherein the wireless network is supported by an IEEE 802.11x standard wireless protocol or Bluetooth, and the wired network comprises an Ethernet connection with access to the internet.

25. The method of claim 21 wherein each of the plurality of electronic displays further comprises one of a LCD, a plasma screen, a CRT, a HDTV display, and a SED TV display, and each of the plurality of electronic displays is placed at a visibly prominent location including hanging from the ceiling, at a checkout line, and in its own enclosure near products sold in the store.

26. The method of claim 1 wherein each of the plurality of communication controls is in a store location not visible to consumers including inside the ceiling, a backroom, in a custom enclosure and attached to back of the electronic display.

27. The system of claim 21 wherein each of the plurality of interface devices comprises any one of a keypad, a touch screen, a card swipe, a magnetic card reader, and a biometric data reader.

28. The method of claim 7 wherein each of the plurality of interface devices has the capability to cache key strokes and to send data representing the user inputs collectively rather than sending one key stroke individually upon each entry.

29. The method of claim 7 wherein each of the plurality of interface devices is powered by at least one of rechargeable batteries, lithium ion batteries, and a solar panel.

30. The method of claim 27 wherein each of the plurality of interface devices is mounted on a shelf-edge or placed in a location where consumers can have easy access while maintaining visual contact with the at least one of the plurality of electronic displays.

31. The method of claim 21 wherein each of the promotions selected by the consumer that is capable of being transmitted to the consumer further comprises at least one of a promotion, discount, sample offer, customer survey, and a combination thereof for both products and/or services.

32. The method of claim 21 wherein the at least one database server is further capable of measuring and analyzing consumer responses to the different advertisements based on the associated user inputs received from the at least one of the plurality of interface devices in the plurality of stores.

33. The method of claim 21 wherein the plurality of communication controls, the plurality of electronic displays, the plurality of points of sales, and the plurality of interface devices located in different stores are communicatively coupled to a same plurality of database servers that are not located in any of the different stores.

34. The method of claim 21 wherein the each of the plurality of the communication controls inside a store is communicatively coupled to one electronic display, multiple interface devices, and at least one point of sale.

41. An apparatus comprising:
a plurality of in-store and out-of-store devices acting to provide integrated multimedia advertising promotions and communications between advertising promoters and in-store consumers, the plurality of devices including:
a plurality of communication controls in-store communicatively coupled to at least one database server out-of-store, a plurality of electronic displays in-store, a plurality of interface devices in-store, and a plurality of points of sales in-store, and to direct information flow among those in-store and out-of-store devices;
the plurality of electronic displays to display different, changeable advertisements selectively downloaded from the at least one database server, according to electronic instructions stored in the plurality of communication controls which are also downloaded from the at least one database server, each of the different promotions contained in each of the different, changeable advertisements is capable of being selectively transmitted to a consumer,
the plurality of interface devices, each to receive user inputs including consumer identifications and identifications of promotions selected by the consumers, according to instructions displayed on the different changeable advertisements associated to the different promotions, and to transmit the user inputs, via the at least one of the plurality of communication controls, to the at least one database server,
the plurality of points of sales capable to receive electronic discount communications in association with the promotions selected by the consumers, from the at least one database server; and
the at least one database server,
to store and to download the different changeable advertisements and the instructions to display the different changeable advertisements on the plurality of electronic displays,
to receive, to store and to associate the user inputs including the consumer identifications and the different promotions selected by the consumers from the plurality of interface devices,
to retrieve contact information of the consumers based on the consumer identifications received from the plurality of interface devices in the plurality of stores, and
to transmit the different promotions selected by the consumers to the consumers.

42. The apparatus of claim 41 wherein the plurality of communication controls are coupled to the plurality of interface devices through a wireless network and are coupled to the at least one database server and the plurality of electronic displays through a wired network.

43. The apparatus of claim 41 wherein the plurality of communication controls are coupled to the plurality of interface devices, the plurality of electronic displays and the plurality of points of sales through a wireless network and is coupled to the at least one database server through a wired network.

44. The apparatus of claims 42 or 43 wherein the wireless network is supported by an IEEE 802.11x standard wireless protocol or Bluetooth, and the wired network comprises an Ethernet connection with access to the internet.

45. The apparatus of claim 41 wherein each of the plurality of electronic displays further comprises one of a LCD, a plasma screen, a CRT, a HDTV display, and a SED TV display, and each of the plurality of electronic displays is placed at a visibly prominent location including hanging from the ceiling, at a checkout line, and in its own enclosure near products sold in the store.

46. The apparatus of claim 41 wherein each of the plurality of communication controls is in a store location not visible to consumers including inside the ceiling, a backroom, in a custom enclosure and attached to back of the electronic display.

47. The apparatus of claim 41 wherein each of the plurality of interface devices comprises any one of a keypad, a touch screen, a card swipe, a magnetic card reader, and a biometric data reader.

48. The apparatus of claim 47 wherein each of the plurality of interface devices has the capability to cache key strokes and to send data representing the user inputs collectively rather than sending one key stroke individually upon each entry.

49. The apparatus of claim 47 wherein each of the plurality of interface devices is powered by at least one of rechargeable batteries, lithium ion batteries, and a solar panel.

50. The apparatus of claim 47 wherein each of the plurality of interface devices is mounted on a shelf-edge or placed in a location where consumers can have easy access while maintaining visual contact with the at least one of the plurality of electronic displays.

51. The apparatus of claim 41 wherein the each of the promotions selected by the consumers further comprises at least one of a promotion, discount, sample offer, customer survey, and a combination thereof for both products and/or services.

52. The apparatus of claim 41 wherein the discount communication comprises a discount transmitted in the form of an electronic coupon relating to the second consumer selected promotion.

53. The apparatus of claim 41 wherein the first consumer selected promotion transmitted to the consumer comprises at least one of a sample offer, a recipe, and a discount in a form further comprises at least one of a fax, an email, a text message and an instant message.

54. The apparatus of claim 41 wherein the at least one of the plurality of database servers is further capable to analyze and to measure consumer responses to the different advertisements based on the associated user inputs received from the at least one of the plurality of interface devices in the plurality of stores.

55. The apparatus of claim 41 wherein the plurality of communication controls, the plurality of electronic displays, the plurality of points of sales, and the plurality of interface devices located in different stores are communicatively coupled to a same plurality of servers that are not located in any of the different stores.

56. The system of claim 41 wherein the each of the plurality of the communication controls inside a store is communicatively coupled to one electronic display, multiple interface devices, and at least one point of sale.
